(19) United States
(12) Patent Application Publication
(10) Pub. No.: US 2014/0201872 A1
(43) Pub. Date: Jul. 17, 2014

(54) COATING COMPOSITION COMPRISING A CELLULOSE ETHER AND STARCH

(71) Applicants: Paul J. Sheskey, Midland, MI (US); Paula C. Garcia Todd, Buffalo Grove, IL (US); Debora L. Holbrook, Pinconning, MI (US); Karen M. Balwinski, Bay City, MI (US); Michael D. Read, Midland, MI (US); Jeffrey D. Michalowski, Midland, MI (US)

(72) Inventors: Paul J. Sheskey, Midland, MI (US); Paula C. Garcia Todd, Buffalo Grove, IL (US); Debora L. Holbrook, Pinconning, MI (US); Karen M. Balwinski, Bay City, MI (US); Michael D. Read, Midland, MI (US); Jeffrey D. Michalowski, Midland, MI (US)

(73) Assignee: Dow Global Technologies LLC, Midland, MI (US)

(21) Appl. No.: 14/237,999

(22) PCT Filed: Aug. 13, 2012
(86) PCT No.: PCT/US2012/050568

§ 371 Date: Feb. 10, 2014

Related U.S. Application Data
(60) Provisional application No. 61/528,882, filed on Aug. 30, 2011.

(51) Int. Cl. C09D 101/28

(52) U.S. Cl. CPC C09D 101/28
USPC 800/298; 427/2.14; 106/162.81; 424/400; 71/11; 426/103

(57) ABSTRACT

Abstract: A coating composition comprising a) a cellulose ether, and b) a water-dispersible starch which has, when measured as a 15 wt.-% dispersion in water at 25° C., a number average particle size of from 0.01 to 2 micrometers and a viscosity of not more than 2000 mPa·s, wherein the weight ratio between the cellulose ether and the water-dispersible starch is from 1:2 to 20:1, is useful for efficiently coating dosage forms with a low moisture permeability.

### FIELD

This invention relates to coating compositions for dosage forms, such as pharmaceutical dosage forms, nutritional supplements, food products, confectionery, or agricultural seeds for providing a film on the dosage form as a protection from environmental conditions like light, humidity, atmospheric gases, etc.

### INTRODUCTION

Cellulose ethers, such as hydroxypropyl methylcellulose (HPMC), methyl cellulose or ethyl cellulose have proven to be very useful in coating compositions due to their inert nature and solubility in a wide range of aqueous or non-aqueous diluents. Coating formulators have been able to produce about 12 wt.-% aqueous solutions of cellulose ethers in water. Further increasing the cellulose ether content, which is a part of the solids content of the coating formulation, increases the viscosity of the cellulose composition to such a level that it becomes unsuitable in practical use. E.g., the cellulose ether composition is hardly sprayable onto the dosage forms. However, for efficiently coating the dosage forms and drying the coated dosage forms it would be highly desirable to provide a coating composition which is sprayable onto dosage forms even if it has high solids content.

To provide coating compositions with a high solids content, the International Patent Application WO 2010/052727 A1 suggests a dry film coating composition for use in pharmaceutical tablets, nutritional supplements, food products, confectionery or agricultural seed which comprises a) a low viscosity cellulosics polymer, such as hydroxypropyl methyl cellulose, hydroxypropyl cellulose, or methyl cellulose, b) modified starch; and c) optionally other water soluble polymers, diluents, glidents, plasticizers and pigments. Component b) is called “Modified Starch (US Grade)”. Unfortunately, WO 2010/052727 A1 does not disclose in what way the starch has been modified. The online encyclopedia Wikipedia lists a large variety of preparing modified starch by treating native starch physically, enzymatically, or chemically to increase their stability against excessive heat, acid, shear, time, cooling, or freezing; to change their texture; to decrease or increase their viscosity; to lengthen or shorten gelatinization time; or to increase their visco-stability. Some people designate acid-treated starch as “modified starch”, which is prepared by treating starch or starch granules with inorganic acids, e.g. hydrochloric acid, breaking down the starch molecule and thus reducing the viscosity. Alternatively, the term “modified starch” means a cold water soluble, pregelatinized or instant starch which thickens and gels without heat. However, although pregelatinized starch is useful for providing aqueous compositions that have a considerably lower viscosity than aqueous compositions comprising regular corn starch at the same concentration, it is still desirable to provide new coating compositions which even have a lower viscosity at the same concentration of starch. Such new coating composition would not require an unduly high amount of liquid diluent to provide a composition that has a sufficiently low viscosity in the form of a liquid composition to be conveniently coated onto dosage forms.

Moreover, it is well known that coating compositions comprising starch do not provide a sufficiently high protection against moisture in some applications where the dosage forms to be coated are sensitive to moisture. Accordingly, it is highly desirable to provide new coating compositions which have low moisture permeability.

### SUMMARY

Surprisingly, it has been found that these objects can be achieved by a coating composition that comprises a cellulose ether and a specific water-dispersible starch at specific weight ratios.

Accordingly, one aspect of the present invention is a coating composition which comprises a) a cellulose ether, and b) a water-dispersible starch having, when measured as a 15 wt.-% dispersion in water at 25° C., a number average particle size of from 0.01 to 2 micrometers and a viscosity of not more than 2000 mPa·s, wherein the weight ratio between the cellulose ether and the water-dispersible starch is from 1:2 to 20:1.

Another aspect of the present invention is a process for preparing this coating composition wherein i) a dispersion of starch particles in an aqueous liquid is prepared such that the starch particles have, when measured as a 15 wt.-% dispersion in water at 25° C., a number average particle size of from 0.01 to 2 micrometers and a viscosity of not more than 2000 mPa·s; ii) the starch dispersion is optionally dried to a water-redispersible starch powder; and iii) the starch dispersion or the water-redispersible starch powder is blended with a cellulose ether and optional ingredients such that the weight ratio between the cellulose ether and the starch is from 1:2 to 20:1.

Yet another aspect of the present invention is a dosage form which has a coating prepared from the coating composition of the present invention.

Yet another aspect of the present invention is a process for coating a dosage form which process comprises the steps of preparing a liquid coating composition of the present invention, optionally preparing foam from the liquid coating composition and applying the liquid or foamed coating composition to the dosage form and drying the coating composition.

### DETAILED DESCRIPTION

A first essential component of the coating composition of the present invention is a cellulose ether. The cellulose ether serves as a film-forming agent. A “cellulose ether,” as used herein, is an ether-linked derivative, either partial or complete, of cellulose. Cellulose ether is produced from cellulose pulp, typically obtained from wood or cotton. The cellulose pulp is converted into alkaline cellulose by alkalizing the cellulose pulp with an alkali hydroxide, and then etherifying the alkalized cellulose in a dry, gas-phase or slurry process with one or more etherifying agents. The molecular weight of these cellulose ethers can then be reduced by depolymerizing the cellulose ether with an acid, such as hydrogen chloride, and optionally neutralizing the depolymerized cellulose ether with a basic compound, such as anhydrous sodium bicarbonate. Alternatively, the cellulose ether may be depolymerized by way of acid catalyzed degradation, oxidative degradation, degradation by high-energy radiation, and degradation by way of microorganisms or enzymes.

The cellulose ether is a water soluble cellulose ether which generally has a solubility in water of at least 2 grams in 100 grams of distilled water at 25° C. and 1 atmosphere. Non-limiting examples of water soluble cellulose ethers include carboxy-C₁-C₃-alkyl celluloses, such as carboxymethyl celluloses; carboxy-C₁-C₃-alkyl hydroxy-C₁-C₃-alkyl celluloses, such as carboxymethyl hydroxyethyl celluloses; C₁-C₃-alkyl celluloses, such as methylcelluloses; C₁-C₃-alkyl hydroxy-C₁₋₃-alkyl celluloses, such as hydroxyethyl methylcelluloses, hydroxypropyl methylcelluloses or ethyl hydroxyethyl celluloses; hydroxy-C₁₋₃-alkyl celluloses, such as hydroxyethyl celluloses or hydroxypropyl celluloses; mixed hydroxy-C₁-C₃-alkyl celluloses, such as hydroxyethyl hydroxypropyl celluloses, mixed C₁-C₃-alkyl celluloses, such as methyl ethyl celluloses, or alkoxy hydroxyethyl hydroxypropyl celluloses, the alkoxy group being straight-chain or branched and containing 2 to 8 carbon atoms.

In an embodiment, the cellulose ether is methylcellulose, hydroxyethyl cellulose, hydroxypropyl cellulose, hydroxyethylmethyl cellulose, hydroxypropylmethyl cellulose, hydroxybutylmethyl cellulose, ethylhydroxyethyl cellulose, carboxymethyl cellulose, and carboxymethyl hydroxyethylcellulose.

In a further embodiment, the cellulose ether is hydroxypropylmethylcellulose (HPMC) or methylcellulose (MC). HPMC and/or MC are available under the METHOCEL trademark from The Dow Chemical Company, Midland, Mich. The hydroxypropylmethylcellulose may be a high-hydroxypropyl cellulose ether or a low-hydroxypropyl cellulose ether. As used herein, a “high-hydroxypropyl cellulose ether” is a hydroxypropylmethylcellulose having 28-30% by weight methoxyl groups and 7.0-12.0% by weight hydroxypropoxyl groups. A non-limiting example of a high-hydroxypropyl cellulose ether is Hypromellose 2910 available from The Dow Chemical Company, Midland, Mich. under the trademark METHOCEL E. A “low-hydroxypropyl cellulose ether” is a hydroxypropylmethylcellulose having 27-30% by weight methoxyl groups and 4.0-7.5% by weight hydroxypropxyl groups. A non-limiting example of a low-hydroxypropyl cellulose ether is Hypromellose 2906 available from The Dow Chemical Company, Midland, Mich. under the trademark METHOCEL F.

The cellulose ethers which are preferably used in the coating composition of the present invention are cellulose ethers which have a molecular weight such that a 2% by weight solution of it in water at 20° C. have a viscosity of from 1.2 mPa·s (millipascal times seconds) to 1000 mPa·s. In an embodiment of the invention the lower viscosity limit is 2 mPa s or 2.5 mPa·s or 3 mPa·s. The higher viscosity limit preferably is 500 mPa·s, more preferably 100 mPa·s, and most preferably 50 mPa·s.

Unless stated otherwise, the viscosity values set forth herein are determined using an Ubbelohde tube. This method of determining the viscosity values using an Ubbelohde tube is described in ASTM D1347-72 (reapproved 1995) (for methyl cellulose) and ASTM D2363-79 (Reapproved 2006) (for hydroxypropyl methylcellulose). The test method described in ASTM D1347-72 (reapproved 1995) and in ASTM D2363-79 (Reapproved 2006) can also be used for other water-soluble cellulose ethers.

Non-limiting examples of suitable HPMC and MC are set forth in Table 1 below.

TABLE 1

| | | | | Viscosity of |
|---|---|---|---|---|
| | | Methoxyl | Hydroxypropyl | 2% solution in |
| METHOCEL ™ Product | Chemical Type | Content, % | Content, % | water, mPa · s |
| METHOCEL ™ A15 | Methylcellulose, | 27.5-31.5 | 0 | 12-18 |
| Premium LV | USP | | | |
| METHOCEL ™ E3 | Hypromellose | 28-30 | 7-12 | 2.4-3.6 |
| Premium LV | 2910 | | | |
| METHOCEL ™ E5 | Hypromellose | 28-30 | 7-12 | 4-6 |
| Premium LV | 2910 | | | |
| METHOCEL ™ E6 | Hypromellose | 28-30 | 7-12 | 5-7 |
| Premium LV | 2910 | | | |
| METHOCEL ™ E15 | Hypromellose | 28-30 | 7-12 | 12-18 |
| Premium LV | 2910 | | | |
| METHOCEL ™ E50 | Hypromellose | 28-30 | 7-12 | 40-60 |
| Premium LV | 2910 | | | |
| METHOCEL ™ F50 | Hypromellose | 27-30 | 4-7.5 | 40-60 |
| Premium | 2906 | | | |
| METHOCEL ™ K3 | Hypromellose | 19-24 | 7-12 | 2.4-3.6 |
| Premium LV | 2208 | | | |
| METHOCEL ™ K100 | Hypromellose | 19-24 | 7-12 | 80-120 |
| Premium LV | 2208 | | | |

A second essential component of the coating composition of the present invention is a special water-dispersible starch. The starch particles have a number average particle size of at least 0.01 micrometers, typically at least 0.05 micrometers as a dispersion in water. The starch particles have a number average particle size of up to 2 micrometers, typically up to 1 micrometer, more typically up to 0.5 micrometers, and most typically up to 0.2 micrometers as dispersion in water. The starch particles have the mentioned number average particle size when they are measured as a 15 wt.-% dispersion in water at 25° C., however the solids concentration and the temperature of the aqueous dispersion does not have a significant influence on the number average particle size. The starch particles have the mentioned number average particle size at any concentration.

Particle size measurements are obtained utilizing a transmission electron microscope (TEM). According to a specific method of measuring particle size, samples of water-dispersible starch are diluted with water and then aspirated onto 400 mesh FORMVAR-coated TEM grids. The grids are immediately placed into a Gatan cryo-transfer holder that is pre-cooled with liquid nitrogen, and then inserted into an FEI-Philips Tecnai 12 TEM operating at 120 keV. The cryo-transfer holder enables the samples to be kept cold and condensation-free while being inserted into the microscope. The holder is warmed to −90° C. and images are recorded digitally using a Gatan Multiscan CCD camera. Particle diameters are then manually measured utilizing a drawing tool. A minimum of forty particles are measured and then the average particle size is calculated. Light scattering techniques are not effective for determining the average particle size diameter of the starch particles as the materials appear to loosely agglomerate, giving inaccurate results.

The starch particles have a viscosity, when measured as a 15 wt.-% dispersion in water at 25° C., of not more than 2000 mPa·s and typically not more than 1000 mPa·s. In various embodiments the thus measured viscosity of the starch particles is not more than 800 mPa·s, typically not more than 600 mPa·s or even not more than 400 mPa·s. The viscosity of the 15 wt.-% dispersion in water advantageously is not less than 1 mPa·s, and in various embodiments is not less than 5 mPa·s, or not less than 10 mPa·s. These viscosities can even be found over a wide range of solids contents. In one embodiment, the viscosity of a dispersion in water is not more than 2000 mPa·s and typically not more than 1,000 mPa·s at a solids content of from 20 to 65 wt.-%. Unless stated otherwise, the mentioned viscosity of the starch particles is measured as a 15 wt.-% dispersion in water at 25° C. 24 hours after production of the dispersion, using a Brookfield viscometer at 100 rpm, spindle no. 3.

Stable dispersions of starch particles in an aqueous liquid can be produced as described below. The solids content of the starch dispersion advantageously is, in various embodiments, at least 15% by weight, at least 35%, at least 40%, or at least 45%, and advantageously is at most 65%, at most 60%, at most 55%, or at most 50% of the starch particles, based on the total weight of the starch dispersion. Any combination of upper and lower limits is possible. In various embodiments, the high solids content is from 20 wt. % to 65 wt. % of the starch particles or 35 to 60 wt. % or 45 to 55 wt. % of the starch particles, based on a total weight of the dispersion.

As used herein, the term “dispersion” means a two-phase system where one phase consists of starch particles, as defined herein, dispersed throughout an aqueous liquid, as defined herein, which forms a continuous phase.

As used herein, the term “aqueous liquid” includes water or water that is mixed with a minor amount of an alcohol. If an alcohol, such as methanol or ethanol, is mixed with water, the alcohol amount is typically not more than 30 weight percent, preferably not more than 15 weight percent, more preferably not more than 5 weight percent, based on the total weight of water and alcohol. Most preferably, only water is used as a liquid.

As used herein, the term “stable” or “stability” means the ability and the duration of the starch particles of the present disclosure to remain as a dispersion in the aqueous liquid due to Brownian movement of the starch particles in the aqueous liquid, where any settling of the starch particles can be reversed by agitation. The stable dispersion of the starch particles of the present disclosure does not gel or “set-up” under the conditions of the dispersion given herein.

Both processes for producing stable dispersions of starch particles in an aqueous liquid start from a known feed starch. The feed starch can be selected from any of a wide variety of sources including corn, potato, tapioca, rice, wheat, barley, etc., including waxy, native, and high amylose starches. Many starches are commercially available. Mixtures of starches can be employed. In one embodiment, the feed starch is unmodified native starch. In one or more embodiments, the feed starch can have a number of different properties and/or forms. These include, but are not limited to, a dry powder and/or an intermediate starch product such as a cake, and/or a slurry having moisture content in the range of equal or less than 80 weight percent, for example, in the range of from 35 to 80 weight percent; or in the alternative from 35 to 75 weight percent; or in the alternative from 35 to 65 weight percent.

A dry feed starch generally does not have more than 8 to 14 percent water by weight absorbed in and/or bound. The feed starch generally has discrete units having an average particle size diameter of 15 to 40 micrometer (μm); for example, from 15 to 35 μm; or in the alternative, from 15 to 30 μm; or in the alternative from 20 to 40 μm. Mixtures of two or more of the feed starches provided herein are also possible, and would be considered to be a “feed starch” as provided and discussed herein.

In one embodiment the aqueous starch dispersion is prepared in a process wherein the feed starch and the aqueous liquid are introduced to an extruder, shear forces are applied in the extruder to the starch and the liquid, preferably in the substantial absence of a cross-linker, and a stable dispersion of starch particles in the aqueous liquid is formed.

The feed starch can be utilized as a dry feed to the extruder or as a prewetted material. When feeding dry starch, a suitable quantity of water, can be continuously or intermittently fed early in the process to provide a wetting medium for the feed starch particles. When utilizing a mixture of water and starch as the feed to the extruder, the solids content can vary widely. For example, it is possible to use a milled starch that has not been dried, e.g. a filter cake, a slurry, etc, as a feed material. It is possible to feed the liquid to a stage of the extruder that is later than the stage to which the starch is fed, which is preferred, and vice versa.

Advantageously, the aqueous liquid is employed in an amount sufficient to provide a mixture that is workable in the extruder. In one embodiment, the amount of aqueous liquid employed in the extruder is from 40 to 60 weight percent, based on the weight of the aqueous liquid and the starch. In one embodiment, the amount of aqueous liquid employed is from 45 to 55 weight percent, based on the weight of the aqueous liquid and the starch. “Dry” starch typically is provided by the starch manufacturer with some amount of water in it, which can be, for example, around 8 to 14%. That water is counted as aqueous liquid in the determination of the amount of liquid in the extruder, and the weight of water is excluded from the calculation of the dry weight of the starch.

In one embodiment, optional additives can be employed. For example, a plasticizer may be present in addition to the aqueous liquid. Examples of plasticizers include a polyol (e.g. ethylene glycol, propylene glycol, polyglycols, glycerol, sucrose, maltose, maltodextrins, and sugar alcohols such as sorbitol), urea, sodium lactate, amino acids, or citric acid esters, at a level of from 5 to 40% by weight based on the dry weight of the starch. However, water can already act as a plasticizer. The total amount of plasticizers (i.e. water and additional plasticizer) preferably is from 5 to 65% by weight, more preferably from 5 to 50% by weight, based on the dry weight of the starch. A lubricant, such as lecithin, other phospholipids or monoglycerids, may also be present, preferably at a level of 0.5 to 2.5% by weight based on the dry weight of the starch. A molecular weight reducing acid modifier, preferably a solid or semi-solid organic acid, such as maleic acid, maleic anhydride, citric acid, oxalic acid, lactic acid, gluconic acid, or a carbohydrate-degrading enzyme, such as amylase, may be present at a level of 0.01 to 5% by weight based on the weight of the starch. While not wishing to be bound by any theory, the acid modifier or enzyme is believed to assist in slight depolymerization which is assumed to be advantageous in the process of producing starch dispersions comprising particles of a specific size. Advantageously, the feed to the extruder is substantially free of a cross-linker. Advantageously, the materials in the extruder contain substantially no cross-linker.

Any suitable extruder can be employed. Extruders are well-known to those skilled in the art and can be designed in various ways. Preferably, the extruder is a co-rotating, self wiping twin screw extruder. In one embodiment, the barrel of the extruder is formed from barrel sections that are bolted, or otherwise fastened, together. Advantageously, the extruder is equipped with temperature control zones. The extruder screw design is advantageously set up to provide kneading and shearing of the contents early in the extruder and distributive mixing late in the extruder. In one embodiment, the extruder has multiple injection points along the length of the machine for liquid injection.

Advantageously, the extruder is equipped with a means for ensuring that the material in the extruder is subjected to the desired amount of specific mechanical energy (SME). For the purposes of this disclosure, specific mechanical energy (SME) is defined as the net input of mechanical energy by the extruder drive per unit mass of material flowing through the system. The units of SME typically are J/g. For example, the extruder can be provided with a back pressure regulator, which is preferred, or a suitable die plate. These devices are well-known to those skilled in the art. A back pressure regulator is preferred as it provides a simple means of varying the pressure in the extruder. The back pressure regulator can be used to maintain a constant discharge pressure in the extrusion system. The back pressure regulator can impose a variable pressure drop via a spring loaded restriction or mechanical restriction in the flow path. A twin-screw extruder is typically run in a partially filled mode, but a restriction imposed by a die plate or back pressure regulator valve at the end of the extruder will cause the end of the extruder to fill completely with material. As the pressure at the exit is raised, the length of the filled region increases. The back pressure regulator provides a rapid means of setting the discharge pressure to a specific value that results in different fill lengths of the extruder. Increasing the length of the filled section increases both the residence time in the extruder and provides more mechanical energy input to the material.

The processing in the extruder is preferably performed at elevated temperatures above room temperature and below the degradation point of the starch. The temperature ranges from 25° C., preferably 30° C., more preferably 40° C., and most preferably 60° C., to at most 140° C. preferably at most 130° C., more preferably at most 120° C., and most preferably at most 110° C. The process is conducted in a manner such that in one embodiment at least 100 J of SME per g of starch is applied, while in other embodiments at least 250 J/g, and at least 500 J/g can be employed, depending on the rheology of the extruder contents. Pressure such as, for example, between 1.5 and 13 bar, may be applied to facilitate processing. In other embodiments, the pressure can be from 3 to 12 bar, or from 5 to 10 bar.

Following extrusion, the starch dispersion can be transferred to a separate vessel with mechanical agitation means where additional water may be added to alter the solids content to any desired level less than the exit solids concentration.

In another embodiment the starch particles are prepared in the form of an aqueous starch dispersion in a process wherein the feed starch and an aqueous liquid are introduced into a rotor stator mixer, the feed starch and the aqueous liquid are maintained in the rotor stator mixer at a temperature ranging from a gelation temperature to less than a solubilization temperature of the feed starch, and the feed starch is sheared into starch particles with the rotor stator mixer to form the stable dispersion of starch particles in the aqueous liquid.

As used herein, the term “rotor stator mixer” refers to a high-shear mixing apparatus that disperses, or transports, the starch particles into the aqueous liquid, as provided herein, by mechanical agitation. In one or more embodiments, the rotor stator mixer includes at least one impeller or rotor, or a series of impellers and/or rotors, powered by a motor, e.g. an electric motor, and at least one stationary component (e.g., a stator) that creates a close clearance gap with the rotor so as to produce an extremely high shear zone for the material (e.g., the feed starch) as it exits the rotor. Factors such as the diameter of the rotor and its rotational speed (e.g. ramps and cycles), the design of the stator ring such as number and rows of teeth, their angle and the distance between the rotor and the stator (e.g., the clearance gap), the residence time and the number of rotor stator mixers used all effect the generation of the dispersion of the starch particles in the aqueous liquid. Examples of such high-shear mixing apparatus include, but are not limited to, batch high shear mixers, inline high shear mixers, ultra high shear inline mixers, and grinding mills (e.g., a Kady Mill).

The feed starch can be introduced into the rotor stator mixer as provided by the manufacturer (e.g., a dry powder, a cake, and/or a slurry) and/or can be pre-wetted prior to introduction into the rotor stator mixer. The amount of water included with the feed starch, regardless of its source, is counted as a part of the aqueous liquid in the determination of the amount of aqueous liquid in the rotor stator mixer. The weight of water is excluded, however, from the calculation of the dry weight of the feed starch. A suitable quantity of the aqueous liquid can be introduced with the feed starch to ensure both absorption of the aqueous liquid into the feed starch and to allow for swelling of the feed starch and for the dispersion of the present disclosure to be formed. In addition, during the initial shearing process of the feed starch and the aqueous liquid there is also believed to be a need to have a sufficient solids content (e.g., feed starch) of the starting mixture to facilitate shearing of the swollen feed starch into a stable dispersion of the starch particles of the present disclosure. In some cases, the rotor/stator mixer can be equipped with a powder feeding attachment which can allow the feed starch and the aqueous liquid to both be fed into the rotor/stator mixer in a continuous fashion. The ratio of flow rates of the two streams can be set to achieve a slurry having the desired amount of aqueous liquid introduced with the feed starch into the rotor stator mixer

In one embodiment, the amount of aqueous liquid introduced with the feed starch into the rotor stator mixer can be from 40 weight percent (wt. %) to 55 wt. %, based on the weight of the aqueous liquid and the feed starch. For example, the amount of aqueous liquid introduced with the feed starch into the rotor stator mixer can be from 40 wt. % to 55 wt. %, from 40 wt. % to 50 wt. %, from 45 wt. % to 55 wt. %, from 45 wt. % to 50 wt. %, or from 50 wt. % to 55 wt. %.

The slurry of the feed starch and the aqueous liquid can be pumped into a rotor/stator mixer, such that it passes through the mixer in a single pass. The temperature and flow rate of the slurry as well as the temperature of the jacket of the rotor/stator mixer can be maintained so the temperature of the slurry is from the gelation temperature to below the solubilization temperature of the feed starch, as discussed herein. Shear force, in ranges provided herein, can then be applied to the feed starch in its swollen state so as to create the dispersion of starch particles, as discussed herein. In some cases a solution of an enzyme as discussed herein (for example water containing 0.15 wt.% enzyme and 0.19 wt.% calcium chloride) can be added continuously into dispersion in the rotor/stator mixer through a separate injection port. In some cases, a second rotor/stator mixer (equipped with a second mixer jacket for cooling) can be placed in line after the rotor/stator mixer to provide additional shear to further reduce the size of the starch particles in the dispersion, if desired.

The feed starch and the aqueous liquid are heated to a temperature ranging from a gelation temperature to below a solubilization temperature of the feed starch. At this temperature, the structure of the feed starch swells as it loses its crystalline structure and absorbs at least a portion of the aqueous liquid to achieve an amorphous structure. The feed starch in its swollen state undergoes shearing to allow for the production of the starch particles of the dispersion. Without wanting to be bound to the theory, the starch particles produced according to the present process are believed to retain the amorphous structure of the swollen feed starch from which they are produced. The starch particles with their amorphous structure also can retain a discrete state in the dispersion of the present disclosure at ambient conditions. In contrast, it is believed that if the solubilization temperature of the feed starch were to be achieved and/or exceeded (e.g., the starch has been “cooked”) and sufficient water is available, the amorphous structure of the feed starch would be destroyed to such an extent that starch particles having the structure and size could not be formed according to the processes of the present disclosure.

In one embodiment, the rotor stator mixer can supply and/or remove heat to achieve and/or maintain the temperature of the feed starch and the aqueous liquid from the gelation temperature to below the solubilization temperature of the feed starch. For example, the rotor stator mixer can include a heating/cooling jacket that can be used to control the temperature of the feed starch and the aqueous liquid inside the rotor stator mixer. In one embodiment, heating and/or cooling can be supplied through steam and/or water having a sufficient temperature difference with the bulk phase of the feed starch and the aqueous liquid to cause heating and/or cooling as desired. The action of the rotor stator may also contribute heat energy to the feed starch and the aqueous liquid, which may have to be removed by the heating/cooling jacket of the rotor stator mixer.

In one embodiment, the temperature at which the feed starch is processed allows for the feed starch to swell so as to achieve a proper size and hydration for shearing to the starch particles, which in turn have a size appropriate for creating Brownian motion sufficient to keep them suspended in the dispersion. Maintaining the feed starch and the aqueous liquid in a temperature range from the gelation temperature to less than the solubilization temperature of the feed starch causes the feed starch to lose its crystalline structure and promotes the absorption of the aqueous liquid. As the crystalline structure is lost and the feed starch absorbs the aqueous liquid it begins to swell. The feed starch, however, does not solubilize in the aqueous liquid (e.g., is not allowed to solubilize in the aqueous liquid) as the temperature of the feed starch in the aqueous liquid does not achieve or exceed the solubilization temperature of the feed starch.

As appreciated, the exact temperature ranges (e.g., from the gelation temperature to less than the solubilization temperature) will be a function of the feed starch selected. By way of example, when waxy corn is used as the feed starch the temperature can range from about 68° C. (the gelation temperature of waxy corn at atmospheric pressure) to about 82° C. (the solubilization temperature of waxy corn at atmospheric pressure), where these temperature values are given as examples with the knowledge that they may be different for different waxy corn grades from different producers and/or based on seasonal changes in the starch raw material.

It is appreciated that the gelation temperature and the solubilization temperature of the feed starch can also be affected by the pressure at which the dispersion process takes place in the rotor stator mixer. Pressure such as, for example, 101 kPa to 3447 kPa, may be applied to facilitate processing. In other embodiments, the pressure can be from 101 kPa to 1379 kPa, or from 101 kPa to 689 kPa. Such exemplary pressure can be suitable for rotor stator mixers that operate as a continuous process, a semi-continuous process and/or a batch process.

In addition to swelling as it absorbs the aqueous liquid, the feed starch in the rotor stator mixer is also exposed to a shear force of sufficient magnitude so as to allow for the formation of the starch particles of the dispersion. In one or more embodiments, the rotor stator mixer can impart specific mechanical energy (SME) sufficient to form the dispersion of the present disclosure. For example, the rotor stator mixer can impart SME in a range of 100 Joules per gram (J/g) of the components that lead to the starch dispersion to 2000 J/g, preferably to 1000 J/g during the shearing of the feed starch into starch particles. The SME can also have other value ranges, which may depend upon the rheology of the aqueous liquid, the feed starch contained in the rotor stator mixer and/or the type and/or configuration of the rotor stator mixer used in the process. For example, the SME value can be from a lower limit of 100 J/g, 150 J/g, or 200 J/g to an upper limit of 2000 J/g, 1000 J/g, 875 J/g, or 750 J/g. The SME provided by the rotor stator mixer can add heat to the bulk phase of the feed starch, the aqueous liquid and the starch particles present therein. Specifically, this energy can be added in and around the shear zone of the rotor stator mixer (the area in and directly around the actual rotor stator and/or mixer structure), which can cause a local temperature increase. The residence time of the feed starch, the aqueous liquid and the starch particles in this area, however, is very short. In addition, the feed starch, the aqueous liquid and the starch particles having been heated in the shear zone are then almost immediately mixed back with the large bulk phase of the aqueous liquid, which help to control the temperature in the range provided herein. This is not the case with other systems, e.g., jet cookers.

In one embodiment, geometries of the rotor and/or the stator can be tuned to achieve a desired SME and/or shear rates for the rotor stator mixer. The operational speed (e.g., the rotations per minute) of the rotor may also be adjusted to create the appropriate amount of shear for the desired particle size reduction. It is also possible to have a stator ring that can be engaged and disengaged relative the rotor. This allows for disengaging the stator from the rotor as the temperature of the feed starch, aqueous liquid and starch particles produced during the process begins to approach, but not exceed the solubilization temperature of the feed starch. It is also possible to adjust a residence time values for the feed starch in the rotor stator mixer by recirculation of the product through the mixing zone of the rotor stator mixer. The rotor stator mixer can also include baffling and/or an independently driven distributive mixing impeller (e.g. turbine or propeller) to ensure adequate mixing and turnover within the rotor stator mixer.

Optional additives can be employed, such as one or more stabilizers, plasticizers, lubricants, molecular weight reducing acid modifiers, or carbohydrate-degrading enzymes. For example, anionic and ionic stabilizers might be added to the dispersion during the shearing process to reduce particle agglomeration during drying. Preferred amounts and types of optional additives are those in the above-described process wherein the starch dispersion is prepared in an extruder.

In one or more embodiments, optional additives can also be added to the dispersions produced in an extruder or a rotor stator mixer as described above. Such additives include, but are not limited to, biocides, anti-microbial additives, a base and/or an acid for pH adjustment, pigments, flavor or fragrance enhancers, inorganic and/or organic inert fillers or pigments, and combinations thereof.

Shearing the feed starch in an extruder or a rotor stator mixer produces starch particles having a number average particle size diameter of from 0.01 to 2 micrometers, with preferred or typical ranges being listed further above. The sizes of the starch particles in the composition of the present invention are typically orders of magnitude smaller than the feed starch. This reduction in size greatly increases the number of starch particles per unit volume, as compared to the use of the feed starch alone. Even though the number of starch particles per unit volume can result in a high solid content, as discussed herein, the viscosity of the dispersion remains surprisingly low at ambient conditions. It is believed that this surprisingly low viscosity can be at least partially attributed to reduced interactions between the starch particles in the process for producing the starch dispersion as described herein, as compared to a situation where the feed starch was fully solubilized before forming the dispersion.

In one embodiment, the starch dispersion is ready to use out of the extruder or the rotor stator mixer as is, as this advantageously reduces the expense associated with drying steps required by some prior art processes to concentrate the material into a powder form. In one embodiment, it may also be possible to add additional water to the dispersion to alter the solid content to a desired level.

It is, however, possible to at least partially, i.e. less than 90 percent, substantially, i.e. at least 90 percent, and/or fully, i.e. at least 98 percent, remove the aqueous liquid from the starch particles of the dispersion to concentrate the solids content of the dispersion or to form a dry redispersible powder of the starch particles for redispersion later. This embodiment of the invention is particularly desirable if the water-dispersible starch is to be stored and/or transported over long distances before it is incorporated into the coating composition of the present invention. At least partially, substantially, and/or fully removing the aqueous liquid from the starch particles of the dispersion can form a dry water-redispersible powder which generally has an average particle size diameter of no larger than 20 μm, for example, no larger than 10 μm; in the alternative, no larger than 5 μm; in the alternative, no larger than 4 μm; in the alternative, no larger than 2 μm. The dry water-redispersible power particles may agglomerate during the drying steps to form larger particles than the starch particles in the dispersion. The agglomerated particles are re-dispersible in water, i.e., they can be dispersed into an aqueous dispersion of starch particles having an average particle size diameter of no larger than 2 μm; for example, from an average particle size diameter of no larger than 1 μm or an average particle size diameter of 10 to 200 nanometers.

Various means for reducing the aqueous liquid content of dispersions and/or for drying the dispersion are known to those skilled in the art. Examples of these means include air drying, forced air drying, spray drying, pressurized filtration and centrifugation, among others. In one embodiment, the dry powder of the starch particles can be further milled to break the particles and/or particle aggregates into the desired size. Preferred ways of producing water-redispersible starch powders from an above-described starch dispersion are spray drying or freeze drying. The dry powder of the starch particles of the present disclosure can then be resuspended in a dispersion at a desired time.

Various optional additives may be used for producing the water-redispersible starch powders, such as one or more dispersing aids. Dispersing aids are materials that facilitate dispersion of one or more material into another. In the case of the present invention, the dispersing aid may facilitate dispersing starch powder in an aqueous phase. The desirable dispersing aids include polyvinyl alcohol (PVOH), cellulose derivatives such as hydroxypropyl cellulose; polymers of methyl vinyl ether; poly vinyl pyrolidone; and copolymers of monomeric acids such as acrylic acid. Other dispersing aids may include small molecule water soluble compounds, such as, sugar, salt, chelating agents and surfactants, preferably anionic surfactants etc.

An anti-caking agent may also be used to control the moisture uptake of such powder materials in order to improve the powder flow behavior and shelf life stability. Typical anti-caking agents include mineral filler such as calcium carbonate, kaolin, barium sulphate, titanium oxide, talc, hydrated alumina, bentonite, calcium sulphoaluminate and silica.

To render a good redispersible material, it is desirable to control the process conditions so that the moisture content of the redispersible starch is in the range of 2-15%, more preferably 5-12%.It is advantageous that the high solid content/low viscosity dispersion can be achieved without chemical modification of the starch particles. It is also believed that the size reduction of the starch particles may lead to enhanced stability and better properties of coatings formed from coating compositions that include the starch dispersion or water-redispersible starch powder prepared from the starch dispersion produced as described above.

In one embodiment, the aqueous dispersion of the above described starch particles, which preferably has been prepared according to the methods above, is blended as is with the above-described cellulose ether and optional ingredients.

In another embodiment, the aqueous dispersion of the above described starch particles is dried as described further above to produce a water-redispersible starch powder which is then blended with the above-described cellulose ether and optional ingredients. In this embodiment the coating composition is in solid form and the water-dispersible starch is present in the coating composition in the form of the water-redispersible starch powder.

The above described cellulose ether a) and starch b) are blended in such a ratio that the weight ratio between the cellulose ether and the starch is at least 1:2, preferably at least 1:1, more preferably at least 1.5:1, and most preferably at least 2:1; and that the weight ratio between the cellulose ether and the starch is up to 20:1, preferably up to 9:1, more preferably up to 5:1, and most preferably up to 4:1. The blend may contain one or more of the above-described cellulose ethers and one or more of the above-described starches, but their total amounts preferably are within the described weight ratios.

Optional additives may be blended with the above described cellulose ether and starch. Such additives include, but are not limited to, coloring agents, flavor and taste improvers, antioxidants, plasticizers, surfactants, solids-loading enhancers, such as inert fillers, a second cellulose ether, a second starch, lubricants, polishing agents, pigments, anti-tack agents, glidants, opacifiers, and any combination thereof. Nonlimiting examples of suitable solids-loading enhancers include high molecular weight water soluble poly(ethylene oxide) polymers (POLYOX™ WSP), acacia, and sugars (such as lactose). The lubricant/polishing agent may, for example, be a wax such as carnauba wax or beeswax. The pigment may, for example be titanium dioxide. The anti-tack agent and/or the glidant may, for example, be talc, collidal silicon dioxide, glyceryl monostearate, and combinations thereof. The opacifier may, for example, be calcium carbonate.

For transporting and storage purposes the coating composition of the present invention preferably is in solid form, i.e. in substantially dry form. In this embodiment the water-dispersible starch is present in the coating composition in the form of a water-redispersible starch powder obtained by drying an aqueous dispersion of a starch having, when measured as a 15 wt.-% dispersion in water at 25° C., a number average particle size of from 0.01 to 2 micrometers and a viscosity of not more than 2000 mPa·s.

A coating composition in substantially dry form generally does not have more than 3 to 15 percent water by weight absorbed in and/or bound to the starch and/or the cellulose ether. Such residual amount of water is not calculated in the amounts of cellulose ether, starch and optional ingredients. The coating composition of the present invention preferably comprises at least 30 percent, more preferably at least 35 percent, and most preferably at least 45 percent of the cellulose ether, preferably comprises up to 94 percent, more preferably up to 80 percent, and most preferably up to 70 percent of the cellulose ether, preferably comprises at least 5 percent, more preferably at least 15 percent, and most preferably at least 25 percent of the water-redispersible starch powder, preferably comprises up to 60 percent, more preferably up to 50 percent, and most preferably up to 35 percent of the water-redispersible starch powder, preferably comprises at least 1 percent, more preferably at least 2 percent, and most preferably at least 5 percent of one or more optional additives, and preferably comprises up to 50 percent, more preferably up to 40 percent, and most preferably up to 30 percent of one or more optional additives, based on the total weight of the solid composition. The coating composition of the present invention may contain one or more of the above-described cellulose ethers and one or more of the above-described starches, but their total amounts preferably is within the described weight ranges.

The coating composition of the present invention is conveniently in liquid form when the coating composition is used for coating dosage forms. The coating composition in liquid form can be produced by adding cellulose ether and optional additives to the dispersion of starch that has been prepared as described above. Alternatively, the coating composition in liquid form can be produced by blending cellulose ether, water-redispersible starch powder, optional additives and a desired amount of aqueous diluent. As used herein, the term “aqueous diluent” includes water or water that is mixed with a minor amount of an alcohol. If an alcohol, such as methanol or ethanol, is mixed with water, the alcohol amount is typically not more than 30 percent, preferably not more than 15 percent, more preferably not more than 5 percent, based on the total weight of water and alcohol. Most preferably, only water is used as a liquid.

When the coating composition of the present invention is in liquid form comprising an aqueous diluent, the sum of cellulose ether a), starch b) and optional additives is preferably from 5 to 40 percent, more preferably from 8 to 30 percent and most preferably from 10 to 20 percent, based on the total weight of the liquid composition, and the amount of the aqueous diluent preferably is from 60 to 95 percent, more preferably from 70 to 92 percent, and most preferably from 80 to 90 percent, based on the total weight of the liquid composition. The coating composition generally has a viscosity of not more than 1000 mPa·s, in preferred embodiments not more than 800 mPa·s, in the more preferred embodiments not more than 600 mPa·s, and in the most preferred embodiments even not more than 560 mPa·s at 25° C., using a Brookfield viscometer at 20 rpm, spindle No. 3. The coating composition of the present invention generally has a viscosity of 50 mPa·s or more, typically 200 mPa·s or more, more typically 350 mPa·s or more or alternatively 450 mPa·s or more, when measured as indicated above.

Provision of the cellulose ether a) and the starch b) in the coating compositions of the present invention has several advantages. The ability to spray the cellulose ether a) and the starch b) at high concentration in aqueous environments render the coating compositions very useful, e.g., as a taste masking agent and as a flavor fixative in oral solid dosage forms, feed, veterinary applications and nutritional supplements. This also improves the visual attractiveness of the resultant coated composition by providing a smooth (non-stippled) surface, and uniform coating without edging. The combination of the cellulose ether a) and the starch b) is also very useful for encapsulation techniques for producing oral solid dosage forms, veterinary and agricultural applications, food, feed, nutritional supplements and cosmetics.

The present disclosure provides aqueous coating compositions with a significantly higher amount of starch particles at a reasonably low viscosity. High concentrations of cellulose ether a) and starch b) do not impair the ability of the film-coating formulations containing these compositions to be atomized or uniformly coated onto a substrate. Because significantly higher film-forming polymer concentrations can be incorporated in the aqueous coating compositions, coating times can be significantly reduced.

Also, it has been found that coatings produced from the coating composition of the present invention have surprisingly low moisture permeability. Specifically, the coatings of the present invention have a much lower moisture permeability than coatings prepared from corresponding coating compositions comprising the same type and amount of a cellulose ether a) but the same amount of feed starch as described further above instead of the starch b) as described herein. Moreover, it has been surprisingly found that coatings produced from the coating composition comprising a cellulose ether a) and a starch b) as described herein even have a lower moisture permeability than coatings prepared from corresponding coating compositions wherein the starch b) has been replaced by a corresponding amount of cellulose ether a). This is highly surprising because coatings prepared from cellulose ethers are generally known to have a lower permeability than coatings prepared from starches.

Liquid coating compositions of the present invention may be applied onto a dosage form and dried to form a coated dosage form. Coating devices such as a fluidized bed coating device, a pan coating device, and/or a flow-through rotational drum type coating device may be used to apply, spray, or atomize the composition onto the exterior of a dosage form. The liquid coating composition can be applied in liquid form or in the form of foam to the dosage form. A process for preparing foam from a liquid composition and a method of applying the foam onto a dosage form is generally described in U.S. Pat. No. 7,070,828.

Non-limiting examples of suitable dosage forms include food products, pharmaceutical products, seeds, animal feed, or fertilizers, for example in the shape of tablets, granules, beads, pellets, caplets, capsules, lozenges, suppositories, pessaries, implantable dosage forms, powder, troches or encapsulates where a particulate material is encapsulated (micro- or macro-encapsulation) by the coating.

Some embodiments of the invention will now be described in detail in the following Examples

### EXAMPLES

Unless otherwise mentioned, all parts and percentages are by weight. In the Examples the following test procedures and materials were used.

The viscosity of the coating composition was measured at 25° C., using a Brookfield viscometer at 20 rpm, spindle no. 3. The sum of the weights of the cellulose ether and the starch is 15 wt.-%, based on the total weight of the cellulose ether, the starch and the water.

The Mocon moisture permeation was measured at 23° C. according to ASTM 1249, but using the MOCON AQUATRAN detector.

METHOCEL™ E6 Premium LV hypromellose was used which is commercially available from The Dow Chemical Company and has a methoxyl Content of 28-30, a hydroxypropyl Content of 7-12 and a Viscosity, measured as a 2% solution in water of 5-7 mPa·s.

Native waxy corn starch (Merizet 300) was used that is commercially available from Tate and Lyle, Koog, Netherlands.

Starch 1500® Partially Pregelatinized Maize Starch was used which is commercially available from Colorcon Inc. Starch 1500 is a known pharmaceutical excipient.

A 10 weight percent solution of calcium chloride in water was used (Calcium chloride from Fischer Scientific, Fair Lawn, N.J.)

Enzyme: enzyme preparation (BAN 480L available from Novozymes A/S, Bagsvaerd, Denmark).

Chelating Agent: chelating preparation in water (VERSENOL 120 available from Dow Chemical, Midland, Mich.).

Water-redispersible starch as used in the present invention was produced according to the following procedure:

### Equipment:

GAW Agitator, model RW 60 S-VST Rotor Stator from GAW Pidlner-Steinburg GmbH, Graz, Austria with 50 hp motor drive and a 473 liter container.

### Procedure:

Prepare the dispersion by first measuring an amount of native waxy corn starch and water, both at room temperature (25° C.), to make a mixture having 45 weight percent solids content. Place 113.4 kg of native waxy corn starch and 126.6 kg of water in the tank of the GAW Mixer body. Set the speed setting of the GAW Mixer to 1800 rpm on the motor drive speed control and mix the mixture having the 45 weight percent solids content for 30 minutes until the resulting dispersion reaches a temperature of 65.5° C. Add 200 parts per million based on dry weight calcium chloride via a 10% solution. Add 0.00005 parts of the enzyme, based on 100 parts of dry native waxy corn starch, to the dispersion and mix for an additional 30 minutes. Reduce the speed setting of the GAW Mixer to 600 rpm on the motor drive speed control. Add the chelating agent at 2000 parts per million and mix the dispersion for an additional 10 minutes.

The result is a stable dispersion of starch particles in the aqueous liquid that does not gel after storage at room temperature (25° C.) for 24 hours.

A redispersible starch powder is made by pumping the starch dispersion to a fountain mode two-fluid nozzle atomizer on a Mobile Minor (GEA Process Engineering Inc, Columbia, Md.) spray dryer. The air pressure to the nozzle is fixed at 1.5 bar with 70% flow which is equivalent to 9 kg/hr of airflow. The spray drying is conducted in an N₂ environment with an inlet temperature fixed at 130° C., and the outlet temperature is targeted to 50° C.±1° C. by tuning the feed rate of the mixture. The spray dried materials are collected by the cyclone. The powder materials are readily dispersible in water.

### Example 1 and Comparative Examples A and B

A coating composition was produced by blending METHOCEL™ E6 Premium LV hypromellose and a starch powder as listed in Table 2 below. Solutions were prepared by quickly dispersing the powder mix into an 800 ml beaker equipped with a 3 blade shaft containing de-ionized water. The rotation rate, during the addition of powder, was set to maintain a vortex that continuously drew the powder into the water (>400 rpm). Solutions were prepared at more than 90° C., stirred (400 rpm) for 2 minutes at a temperature above 80° C., then covered and stirred (400 rpm) for an additional 3 hours at room temperature. All solutions prepared were then hydrated in a refrigerator (about 5° C.) overnight (more than 18 hours) to ensure complete hydration of the polymer.

The weight ratio of hypromellose:starch powder was 7:3 and the sum of the weights of hypromellose and starch powder was 15 percent, based on the total weight of hypromellose, starch and water. The viscosity of the coating compositions was measured at 23° C. on a Brookfield Digital Viscometer DVII (model RVTDV II-20). The instrument was equipped with a spindle specific for the viscosity range that was being analyzed (spindle # 3). The viscosity readings of each solution were completed and recorded at 10 and 20 rpm. The viscosity readings at 20 rpm are listed in Table 2 below.

TABLE 2

| Composition | Viscosity (mPa · s) |
|---|---|
| Example 1: | 550 |
| hypromellose/water-redispersible starch | |
| powder/water | |
| Comparative Example A: | 3360 |
| hypromellose/Native corn starch/water | |
| Comparative Example B: | 1150* |
| hypromellose/Starch 1500 ®/water | |

*Viscosity may not be representative of actual composition due to non-uniform sample. The sample was not uniform due to poor dispersibility of the starch.

The results in Table 2 illustrate that the coating composition of the present invention has a much lower viscosity than comparable coating compositions including known starches at the same solids content and the same type and amount of cellulose ether.

Films were prepared from the liquid coating compositions above as follows: All film preparation and storage was completed at 22° C. and 50% relative humidity. Wet films of 1mm thickness were hand drawn on glass plates by slowly pouring the 15% solutions near the edges of 1mm casting bars and then steadily drawing the solution to minimize bubbles and defects. The films of 4×8 inch (10.2×20.3 cm) were dried on the plates for two days, removed, and annealed for an additional day before any film properties were measured. All film testing was concluded within 4 days of film removal to minimize sample to sample variance. Prior to each test, the sample thickness was measured on each specimen. The moisture permeation of the free films was measured on a Mocon Permatran-W® Model 3/33, Water Vapor Transmission Rate Test System, available from MOCON Inc., USA. The testing was performed at 23° C. and 100% relative humidity at a flow rate of 100 SCCM (standard cm³/min at 0° C. and 1.013 bar). The results are listed in Table 3 below

TABLE 3

| | Mocon moisture permeation |
|---|---|
| Composition | [gm/(cm hour)] |
| Example 1: | 1.050E−05 |
| hypromellose/water redispersible starch | |
| Comparative Example A: | 9.252E−05 |
| hypromellose/Native corn starch | |
| Comparative Example B: | Not assessed* |
| hypromellose/Starch 1500 ® | |
| hypromellose, 15% in water | 1.493E−05 |

*A film could not be made from this formulation due to clumpy, non-uniform mixture

The results in Table 3 illustrate the surprisingly low moisture permeation through the free film of the present invention, which is even lower than the corresponding free film wherein the starch has been replaced by the same amount of hypromellose.

### Example 2 and Comparative Examples C and D

A coating composition was produced by blending METHOCEL™ E6 Premium LV hypromellose and a starch powder as described in Example land Comparative Examples A and B. The weight ratio of hypromellose:starch powder was 7:3 as in Example 1 and Comparative Examples A and B, but the sum of the weights of hypromellose and starch powder was 20 percent, based on the total weight of hypromellose, starch and water. The viscosities were measured as in Example 1 and Comparative Examples A and B and are listed in Table 4 below. Example 2 illustrates that even at high solids concentration the coating composition has a sufficiently low viscosity in the form of a liquid composition to be conveniently coated onto dosage forms.

TABLE 4

| Composition | Viscosity (mPa · s) |
|---|---|
| Example 2: | 2000 |
| hypromellose/water-redispersible starch | |
| powder/water | |
| Comparative Example C: | 8800 |
| hypromellose/Native corn starch/water | |

1. A coating composition comprising
a) a cellulose ether, and
b) a water-dispersible starch having, when measured as a 15 wt.-% dispersion in water at 25° C., a number average particle size of from 0.01 to 2 micrometers and a viscosity of not more than 2000 mPa·s,
wherein the weight ratio between the cellulose ether and the water-dispersible starch is from 1:2 to 20:1.

2. The coating composition of claim 1 wherein the weight ratio between the cellulose ether and the water-dispersible starch is from 1:1 to 9:1.

3. The coating composition of claim 1 wherein the cellulose ether is a cellulose ether having a viscosity of from 1.2 to 1000 mPa·s, measured as a 2 wt.-% weight solution in water at 20° C.

4. The coating composition of claim 1 wherein the cellulose ether is hydroxypropyl methylcellulose or methylcellulose.

5. The coating composition of claim 1 wherein the coating composition is in solid form and the water-dispersible starch is present in the coating composition in the form of a water-redispersible starch powder obtained by drying an aqueous dispersion of a starch having, when measured as a 15 wt.-% dispersion in water at 25° C., a number average particle size of from 0.01 to 2 micrometers and a viscosity of not more than 2000 mPa·s.

6. The coating composition of claim 1 wherein the coating composition is in solid form and comprises from 30 to 94 percent of the cellulose ether, from 5 to 60 percent of the water-redispersible starch powder and optionally from 1 to 50 percent of one or more additives, based on the total weight of the solid composition.

7. The coating composition of claim 1 wherein the water-dispersible starch is present in the coating composition in the form of an aqueous dispersion.

8. The coating composition of claim 1 wherein the coating composition is in liquid form comprising an aqueous diluent and the sum of the cellulose ether, the starch and optional additives is from 5 to 40 percent, based on the total weight of the liquid composition, and the amount of the aqueous diluent is from 60 to 95 percent, based on the total weight of the liquid composition.

9. The coating composition of claim 1 having a viscosity of not more than 1000 mPa·s, measured at 25° C. using a Brookfield viscometer at 20 rpm, spindle No. 3.

10. A process for preparing the coating composition of claim 1 wherein
i) a dispersion of starch particles in an aqueous liquid is prepared such that the starch particles have, when measured as a 15 wt.-% dispersion in water at 25° C., a number average particle size of from 0.01 to 2 micrometers and a viscosity of not more than 2000 mPa·s;
ii) the starch dispersion is optionally dried to a water-redispersible starch powder; and
iii) the starch dispersion or the water-redispersible starch powder is blended with a cellulose ether and optional ingredients such that the weight ratio between the cellulose ether and the starch is from 1:2 to 20:1.

11. The process of claim 10 wherein the dispersion of starch particles is prepared by introducing a feed starch and an aqueous liquid to an extruder, and applying shear forces in the extruder to the starch and the aqueous liquid to form the dispersion of starch particles in the aqueous liquid.

12. The process of claim 10 wherein the dispersion of starch particles is prepared by introducing a feed starch and the aqueous liquid into a rotor stator mixer; maintaining the feed starch and the aqueous liquid in the rotor stator mixer at a temperature ranging from a gelation temperature to less than a solubilization temperature; and shearing the feed starch into starch particles with the rotor stator mixer to form the dispersion of starch particles in the aqueous liquid.

13. A dosage form having a coating prepared from the coating composition of claim 1.

14. A process for coating a dosage form which process comprises the steps of preparing a liquid coating composition according to the process of claim 1, optionally preparing foam from the liquid coating composition and applying the liquid or foamed coating composition to the dosage form and drying the coating composition.

15. The coating composition of claim 4 wherein the coating composition is in solid form and comprises from 30 to 94 percent of the cellulose ether, from 5 to 60 percent of the water-redispersible starch powder and optionally from 1 to 50 percent of one or more additives, based on the total weight of the solid composition.

16. The coating composition of claim 15 wherein the coating composition is in solid form and comprises from 30 to 94 percent of the cellulose ether, from 5 to 60 percent of the water-redispersible starch powder and optionally from 1 to 40 percent of one or more additives, based on the total weight of the solid composition.

17. The process of claim 10 wherein
i) the dispersion of starch particles in an aqueous liquid is prepared;
ii) the starch dispersion is dried to a water-redispersible starch powder; and
iii) the water-redispersible starch powder is blended with a cellulose ether and optional additives to prepare a coating composition comprising from 30 to 94 percent of the cellulose ether, from 5 to 60 percent of the water-redispersible starch powder and optionally from 1 to 50 percent of one or more additives, based on the total weight of the solid composition.

18. A dosage form having a coating prepared from a coating composition comprising from 30 to 94 percent of the cellulose ether, from 5 to 60 percent of the water-redispersible starch powder and optionally from 1 to 50 percent of one or more additives, based on the total weight of the solid coating composition.
